(19) United States
(12) Patent Application Publication
(10) Pub. No.: US 2023/0131938 A1
(43) Pub. Date: Apr. 27, 2023

(54) Techniques For Accessing Memory Circuits

(71) Applicant: Intel Corporation, Santa Clara, CA (US)

(72) Inventors: Scott Weber, Piedmont, CA (US); Chang Kian Tan, Penang (MY); Rajiv Kumar, Penang (MY); Saravanan Sethuraman, Hillsboro, OR (US)

(73) Assignee: Intel Corporation, Santa Clara, CA (US)

(21) Appl. No.: 18/085,819

(22) Filed: Dec. 21, 2022

(51) Int. Cl. G06F 3/06

(52) U.S. Cl. CPC G06F 3/0613; G06F 3/0656; G06F 3/0659; G06F 3/0673

(57) ABSTRACT

An integrated circuit includes a buffer circuit, a memory circuit, and a controller circuit that determines if the memory circuit stores information that is valid and determines whether to transmit the information stored in the memory circuit to the buffer circuit based on credits that indicate an amount of storage space available in the buffer circuit. The controller circuit transmits the information to the buffer circuit if the credits indicate that sufficient storage space is available in the buffer circuit to store the information.

### FIELD OF THE DISCLOSURE

The present disclosure relates to electronic integrated circuits and, in particular, to memory circuits in electronic integrated circuits.

### BACKGROUND

Integrated circuits such as programmable logic devices (PLDs) typically include data storage circuitry such as memory circuits. As applications continue to demand more data at higher data rates, memory circuits in programmable logic devices need to increase data input and output bandwidth capabilities to scale with these applications.

In general, the memory circuits in programmable logic devices can be formed from multiple smaller portions of memory circuits that are connected using programmable interconnects within the programmable logic devices. However, using the programmable interconnects in the general routing fabric for high bandwidth routing to and from the memory circuits strains these portions of the general routing fabric, resulting in high routing congestion and degrading the maximum operating frequency or increasing clock latency of the programmable logic device.

### BRIEF DESCRIPTION OF THE DRAWINGS

FIG. 1 is a diagram that illustrates an example of a configurable memory block circuit that can be configured to implement different memory functions.

FIG. 2 is a diagram that depicts examples of circuits that can be used to implement a memory interface circuit.

FIG. 3 is a diagram that illustrates an example of a memory interface circuit that includes a response buffer circuit, a network-on-chip (NOC) bus, controller circuits, and memory circuits.

FIG. 4 is a flow chart that illustrates examples of operations that can be performed to implement one or more write operations from one or more of the memory circuits through a bus to the response buffer circuit in the memory interface circuit of FIG. 3.

FIG. 5 illustrates an example of a programmable logic integrated circuit (IC) that can include circuits disclosed herein.

### DETAILED DESCRIPTION

This disclosure discusses integrated circuit devices, including configurable (programmable) logic devices such as field programmable gate arrays (FPGAs). As discussed herein, an integrated circuit (IC) can include hard logic and/or soft logic. As used herein, “hard logic” generally refers to circuits in an integrated circuit device that are not programmable by an end user. The circuits in an integrated circuit device (e.g., in a configurable IC) that are programmable by the end user are referred to as “soft logic.”

Throughout the specification, and in the claims, the term “connected” means a direct electrical connection between the circuits that are connected, without any intermediary devices. The term “coupled” means either a direct electrical connection between circuits or an indirect electrical connection through one or more passive or active intermediary devices. The term “circuit” may mean one or more passive and/or active electrical components that are arranged to cooperate with one another to provide a desired function.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In some applications, such as deep learning applications for vision, voice, gesture recognition, memory in an integrated circuit may need to handle high data bandwidth in and out of the memory (e.g., receive large amounts of data from external sources, feed large amounts of data to processing cores on the integrated circuit). To properly buffer the large amounts of data, memory can be formed by connecting smaller memory blocks to each other. However, implementing these connections between smaller memory blocks using the routing fabric in the integrated circuit can cause significant routing congestion. To mitigate these problems, circuit designs would have to include undesirable design limitations that provide suboptimal performance in these data-hungry applications.

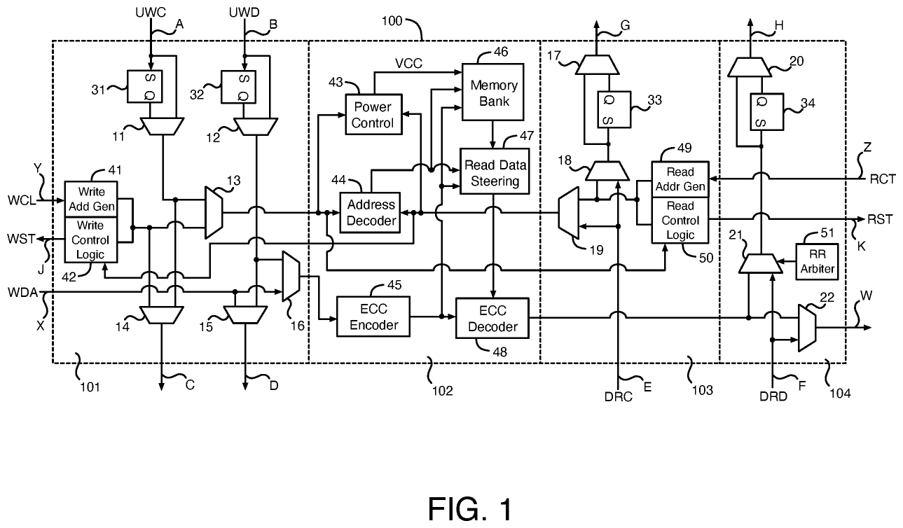

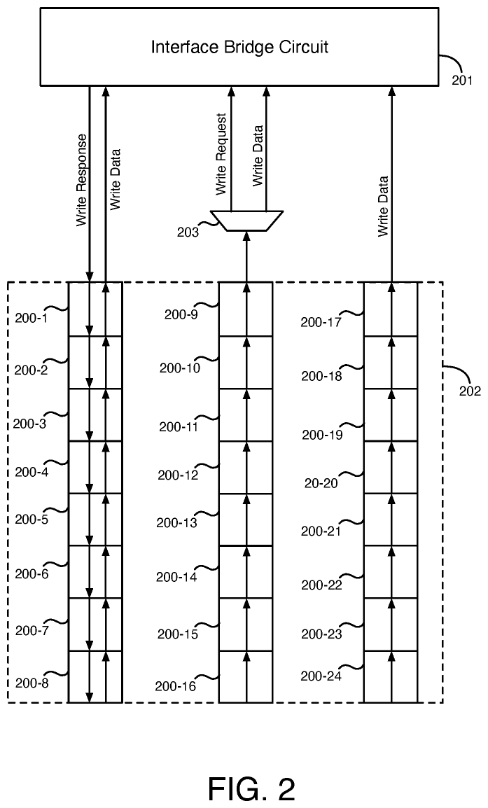

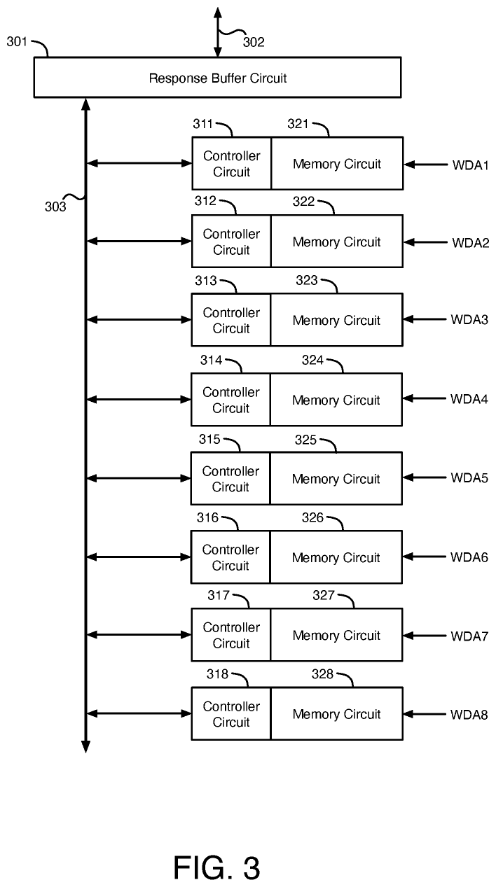

To more efficiently implement memory in integrated circuits, smaller memory circuits can include configurable input and output circuits. FIG. 1 is a diagram that illustrates an example of a configurable memory block circuit 100 that can be configured to implement different memory functions. Configurable memory block circuit 100 can be provided in any type of integrated circuit (IC), such as for example, a configurable logic IC, a microprocessor IC, a graphics processing unit (GPU) IC, a memory IC, an application specific IC (ASIC), etc. Although only one configurable memory block circuit 100 is shown in FIG. 1, the IC can have any number of configurable memory block circuits 100 that are coupled together in a chain, as disclosed in further detail herein with respect to FIGS. 2-3.

As shown in Figure (FIG. 1, configurable memory block circuit 100 can include memory and control circuitry 102, configurable memory input circuits 101 and 103, and configurable memory output circuit 104. Memory and control circuitry 102 includes a memory bank circuit 46 (e.g., including an array of static or dynamic random access memory cells) that can store data. Memory and control circuitry 102 also includes a power control circuit 43 that receives, from configurable memory input circuit 101 or 103, a power control input signal that determines the operational state of configurable memory block circuit 100. For example, the power control input signal from configurable memory input circuit 101 or 103 can indicate whether configurable memory block circuit 100 is to be placed in a normal (active) operating mode, in an off (inactive) operating mode, in a standby (sleep) operating mode, or any other operating modes. Power control circuit 43 can be coupled to memory bank circuit 46 and provide a power level (e.g., a supply voltage VCC) corresponding to the operation mode of the received power control input signal to memory bank circuit 46 (and/or to any other portions of memory and control circuitry 102).

Memory and control circuitry 102 also includes an address decoder circuit 44 that receives, from configurable memory input circuits 101 and 103, and decodes address signals for reading data from and writing data into the memory cells at the associated addresses in memory bank circuit 46. If desired, address decoder circuit 44 can receive other signals, such as enable signals or other operational control signals.

Memory and control circuitry 102 also includes an error-correction code (ECC) encoder circuit 45 that receives write data from a multiplexer circuit 16 in the configurable memory input circuit 101. Address decoder circuit 44 and ECC encoder circuit 45 are coupled to memory bank circuit 46 and provide address signals, write data, error correction code data, and other signals to memory bank circuit 46 (e.g., to store the write data in memory cells at the corresponding addresses, to store the error correction code data in memory cells at the corresponding addresses, etc.).

Memory and control circuitry 102 also includes read data steering circuit 47 coupled to address decoder circuit 44, ECC encoder circuit 45, and memory bank circuit 46. Read data steering circuit 47 can receive read data output from memory bank circuit 46 and provide the read data to ECC decoder circuit 48 for performing error correction on the read data using error correction codes. The read data can be read from one or more memory cells at an address or addresses indicated by a read address signal provided from address decoder circuit 44. ECC decoder circuit 48 can provide the error corrected read data to multiplexer circuits 21-22 in the configurable memory output circuit 104.

Configurable memory input circuits 101 and 103 can each have input ports and output ports for memory and control circuitry 102 (e.g., writing data into memory bank circuit 46 or providing addresses to read data from memory bank circuit 46). The input ports in configurable memory input circuit 101 include one or more write data input ports X and B and one or more write address and control input ports Y and A. Input ports X and Y can be coupled directly to adjacent logic circuits (e.g., programmable logic circuits) in the same IC as configurable memory block circuit 100. Input ports A and B can be coupled directly to the configurable memory input circuit 101 of a second instance of the configurable memory block circuit 100 in the same IC (or other data storage circuits if desired).

Ports B and X can be configured to accommodate write data of any suitable width. Write data signals UWD received on port B can be provided through multiplexer circuit 12, optionally via SR flip-flop circuit 32 (e.g., a register), and multiplexer circuit 16 to ECC encoder circuit 45. Write data signals WDA received on port X can be provided through multiplexer circuit 16 to ECC encoder circuit 45. Write data signals UWD or WDA can be provided to a third instance of the configurable memory block circuit 100 in the same IC through multiplexer circuit 15 and an output port D.

Ports A and Y can receive any suitable control and address signals such as a read enable signal, a write enable signal, a power control signal (that is provided to power control circuit 43), and an address signal indicative of a read and/or write address or addresses of any suitable width. One or more control and address signals UWC received on port A can be provided through multiplexer circuit 11, optionally via SR flip-flop circuit 31 (e.g., a register), and multiplexer circuit 13 to address decoder circuit 44. One or more control signals WCL received on port Y can be provided to write address generator circuit 41. Write address generator circuit 41 generates write addresses (e.g., write pointers) that are provided through multiplexer circuit 13 to address decoder circuit 44. Signals UWC or WCL can be provided to the third instance of the configurable memory block circuit 100 through multiplexer circuit 14 and an output port C. Ports C and D are coupled to the configurable memory input circuit 101 in the third instance of the configurable memory block circuit 100.

The configurable memory input circuit 103 and configurable memory output circuit 104 include a read data input port F, read control input ports E and Z, and output ports K, W, H, and G. Ports K, W, and Z can be coupled directly to adjacent logic circuits (e.g., programmable logic circuits) in the same IC as configurable memory block circuit 100. Input ports E and F can be coupled directly to the third instance of the configurable memory block circuit 100 in the same IC. Port F can be configured to accommodate read data of any suitable width. Read data signals DRD received on port F can be provided through multiplexer circuit 21, optionally via SR flip-flop circuit 34 (e.g., a register), and multiplexer circuit 20 to the second instance of the configurable memory block circuit 100 through port H. The decoded read data output by the ECC decoder circuit 48 can be provided through multiplexer circuit 21, optionally via SR flip-flop circuit 34, and multiplexer circuit 20 to the second instance of the configurable memory block circuit 100 through port H. The selection of the multiplexer circuit 21 is controlled by a round robin (RR) arbiter circuit 51. The round robin arbiter circuit 51 is used to manage traffic through multiplexer circuit 21 between the read data signals DRD and the read data accessed from memory bank circuit 46 and output by ECC decoder circuit 48. The decoded read data output by the ECC decoder circuit 48 can also, or alternatively, be provided through multiplexer circuit 22 to the adjacent logic circuits in the IC through port W.

Ports E and Z can receive any suitable control and address signals such as a read enable signal, a write enable signal, a power control signal (that is provided to power control circuit 43), and an address signal indicative of a read and/or write address (or addresses) of any suitable width. The control and address signals DRC received on port E can be provided through multiplexer circuit 19 to address decoder circuit 44 for performing read operations to memory bank circuit 46. One or more read control signals RCT received on port Z are provided to read address generator circuit 49. Read address generator circuit 49 generates read addresses (e.g., read pointers) that are provided through multiplexer circuit 19 to address decoder circuit 44 for performing read operations to memory bank circuit 46. Signals DRC received at port E, or the read addresses output by read address generator circuit 49, can be provided to the second instance of the configurable memory block circuit 100 through multiplexer circuits 17-18 (optionally via SR flip-flop circuit 33) and through port G.

The write address generator circuit 41 generates the write addresses (e.g., write pointers) in response to write control signals WCL at port Y to perform write operations to the memory bank circuit 46. Each write operation can, for example, cause the write addresses to increment to the next memory location sequentially in the memory bank circuit 46. Similarly, the read address generator circuit 49 generates the read addresses (e.g., read pointers) in response to read control signals RCT at port Z to perform read operations to the memory bank circuit 46. Each read operation can, for example, cause the read addresses to increment to the next memory location sequentially in the memory bank circuit 46.

Configurable memory block circuit 100 can be operated in a first-in-first-out (FIFO) mode as a FIFO buffer circuit. In the FIFO mode, a write control logic circuit 42 generates write status control signals WST on an output port J in response to the write addresses generated by the write address generator circuit 41 and in response to the read addresses generated by the read address generator circuit 49 (or indicated by signals DRC) and received via multiplexer 19. Also in the FIFO mode, a read control logic circuit 50 generates read status control signals RST on output port K in response to the read addresses generated by the read address generator circuit 49 and in response to the write addresses generated by the write address generator circuit 41 (or indicated by signals UWC) and received via multiplexer 13. The write status control signals WST and the read status control signals RST are used to keep track of the status of a queue in the memory bank circuit 46 during the FIFO mode.

The write and read status control signals can, for example, indicate when the queue in memory bank circuit 46 is full or empty in the FIFO mode. The write status control signals WST can indicate that the queue in memory bank circuit 46 is full when the separation between the read pointer and the write pointer (i.e., the read and the write addresses) reaches a predefined full value. The read status control signals RST can indicate that the queue in memory bank circuit 46 is empty when the separation between the read pointer and the write pointer (i.e., the read and the write addresses) reaches zero. The separation between the read and write pointers can, for example, be measured by a counter circuit and a comparator circuit in each of the write and read control logic circuits 42 and 50.

Implementing the write and read control logic circuits 42 and 50 and the write and read address generator circuits 41 and 49 in hard logic in configurable memory block circuit 100 eliminates the use of soft logic for the counter circuit, the comparator circuit, and the full/empty signal generation. Implementing these circuits in hard logic also enables several configurable memory block circuits 100 to be coupled together in a chain to build a deep FIFO queue having a large width, without reducing the maximum frequency of operation. A chain of the configurable memory block circuits 100 provides a substantial dynamic and static power savings, compared to a memory circuit that uses a soft logic queue, by using more fine-gain dynamic power-up of only the configurable memory block circuits 100 in the chain that are used. Configurable memory block circuit 100 also resolves issues with internal latencies during a de-assertion of empty during a write operation, or during a de-assertion of full during a read operation.

FIG. 2 is a diagram that depicts examples of circuits that can be used to implement a memory interface circuit. The circuits shown in FIG. 2 include an interface bridge circuit 201, a fabric region 202, and a demultiplexer circuit 203. The circuits shown in FIG. 2 can, for example, be provided in a single integrated circuit (IC), such as for example, a configurable logic IC, a microprocessor IC, a graphics processing unit IC, a memory IC, an application specific IC, etc. The fabric region 202 can, for example, be a programmable core fabric region of a configurable logic IC that includes programmable logic circuits. In the example of FIG. 2, the fabric region 202 includes 24 memory block circuits 200-1 to 200-24 and additional logic circuits. The additional logic circuits can be, for example, programmable combinatorial or sequential logic circuits. Each of the 24 memory block circuits 200-1 to 200-24 can be an instance (i.e., a copy) of the configurable memory block circuit 100 of FIG. 1 or any other type of memory circuit.

The interface bridge circuit 201 is an interface circuit coupled between fabric region 202 and a device (e.g., an IC) that is external to the circuitry shown in FIG. 2. The interface bridge circuit 201 is configurable to provide write requests and write data between the external device and the memory block circuits 200-1 to 200-24 in the fabric region 202. In the example of FIG. 2, the memory block circuits 200-1 to 200-24 are coupled together (cascaded) to form three chains, each having 8 memory block circuits 200. The first chain includes memory block circuits 200-1 to 200-8. The second chain includes memory block circuits 200-9 to 200-16. The third chain includes memory block circuits 200-17 to 200-24.

In the example of FIG. 2, the second chain is configured to provide a write request and write data for the write request from one or more of memory block circuits 200-9 to 200-16 through demultiplexer circuit 203 to interface bridge circuit 201. The demultiplexer circuit 203 can be part of a bus, such as a micro network-on-chip. The first chain can be, for example, a write response channel (e.g., channel B in an Advanced Extensible Interface (AXI) protocol) that indicates the successful completion of a write transaction. The first chain is configured to perform bi-directional data accesses to memory block circuits 200-1 to 200-8. A write response is provided to one or more of memory block circuits 200-1 to 200-8 from interface bridge circuit 201 in response to a write request, and write data is provided from one or more of memory block circuits 200-1 to 200-8 to interface bridge circuit 201 for the write request. Write data is also provided from one or more of memory block circuits 200-17 to 200-24 to interface bridge circuit 201 for a write request.

According to some examples disclosed herein, an integrated circuit includes a buffer circuit, one or more memory circuits, and one or more controller circuits. The controller circuits determine whether to transmit information stored in the memory circuits to the buffer circuit based on credits that indicate an amount of storage space available in the buffer circuit. The controller circuits transmit the information to the buffer circuit if the credits indicate that sufficient storage space is available in the buffer circuit to store the information.

FIG. 3 is a diagram that illustrates an example of a memory interface circuit. The memory interface circuit of FIG. 3 includes a response buffer circuit 301, a micro network-on-chip (NOC) bus 303, 8 controller circuits 311-318, and 8 memory circuits 321-328. The memory circuits 321-328 are coupled to the memory controller circuits 311-318, respectively. FIG. 3 also shows another NOC bus 302 coupled to the response buffer circuit 301. Each of the busses 302-303 can include one or more conductors (e.g., wires), multiplexer circuits, and/or buffer circuits that buffer signals transmitted through the conductors. Busses 302-303 can be operated according to any on-chip communication bus protocol, such as the Advanced Extensible Interface (AXI) protocol.

According to an example, the controller circuits 311-318, the memory circuits 321-328, and bus 303 can be implemented by 8 instances of the configurable memory block circuit 100 of FIG. 1. In this example, each of the memory circuits 321-328 can include an instance of memory bank circuit 46. Each of the controller circuits 311-318 can include one or more of write address generator circuit 41, write control logic circuit 42, address decoder circuit 44, ECC encoder circuit 45, read data steering circuit 47, ECC decoder circuit 48, read address generator circuit 49, read control logic circuit 50, and possibly additional control circuitry not shown in FIG. 1. In this example, the bus 303 can include the multiplexer circuits 11-16 in the 8 instances of the configurable memory block circuit 100.

The memory circuits 321-328 can be any types of memory circuits. 8 memory circuits and 8 controller circuits are shown in FIG. 3 as an example that is useful to provide memory circuits with data widths that are multiples of 8 (e.g., 32 or 64) by combining sets of the memory circuits 321-328. It should be understood that memory interface circuits using the techniques disclosed herein can have any number of memory circuits and any number of controller circuits. The memory circuits can be combined in any N×M arrangement (where N is the number of memories and M is the memory depth) to provide a wider interface to the response buffer circuit 301. The circuits shown in FIG. 3 can, for example, be provided in an integrated circuit (IC), such as, a configurable logic IC, a microprocessor IC, a graphics processing unit IC, a memory IC, an application specific IC, etc.

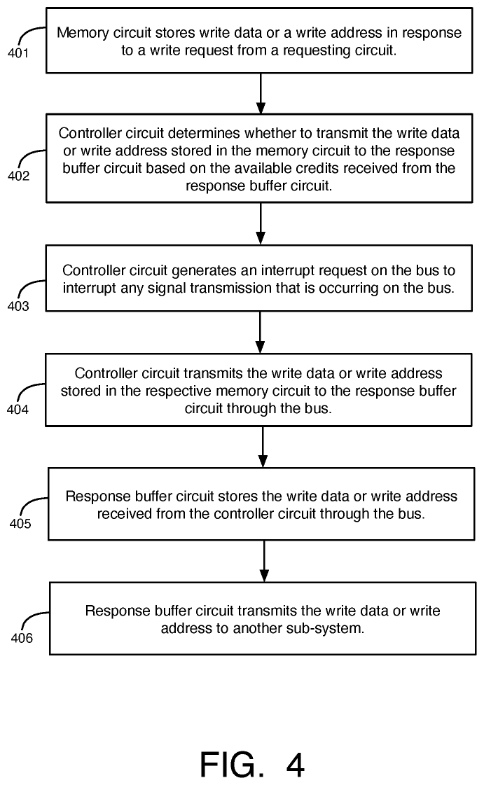

FIG. 4 is a flow chart that illustrates examples of operations that can be performed to implement one or more write operations from one or more of the memory circuits 321-238 through bus 303 to the response buffer circuit 301 in the memory interface circuit of FIG. 3. In operation 401, one of the memory circuits 321-328 stores write data or one or more write addresses in response to a write request from a requesting circuit (e.g., a logic circuit in fabric region 202 of FIG. 2). For example, the requesting circuit can provide the write request and the write data or write addresses to any one of memory circuits 321-328 in a respective set of the signals WDA1-WDA8, and the respective memory circuit 321-328 can store the received write data or write addresses in operation 401. Operation 401 can, for example, be repeated to store write data or write addresses in each of the memory circuits 321-328, or in a subset thereof. Write data and/or one or more write addresses are also referred to herein generally as information.

The response buffer circuit 301 stores and manages credits that indicate how much memory storage space is available in the response buffer circuit 301 for storing write data or write addresses received from the memory circuits 321-328 through bus 303. The response buffer circuit 301 increases the number of the credits available to store write data and write addresses received from memory circuits 321-328 in response to additional storage space that has been allocated to memory circuits 321-328 becoming available in the response buffer circuit 301. The response buffer circuit 301 decreases the number of the credits available in response to storing write data and write addresses received from memory circuits 321-328 in the storage space that has been allocated to memory circuits 321-328. The FIFO mode described above with respect to FIG. 1 can be used for monitoring how much valid data or addresses are stored in memory, for example, if one or more of the memory circuits 321-328 includes an instance of configurable memory block circuit 100. Valid data or a valid address being stored in the memory and the credits having non-zero values triggers the corresponding controller circuit to have the bus 303 read data from the memory.

If there is a lag in the allocation and availability of the credits, the response buffer circuit 301 does not under-estimate the credits available so that any write data or write addresses received through bus 303 are stored in the response buffer circuit 301. The credits can be provided from the response buffer circuit 301 to the controller circuits 311-318 through the bus 303 or through other conductors. In operation 402, one of the controller circuits 311-318 determines whether to transmit write data or one or more write addresses stored in the respective memory circuit 321-328 to the response buffer circuit 301 based on the available credits received from the response buffer circuit 301 and based on the presence of valid write data or a valid write address being stored in the respective memory circuit.

The controller circuit initially determines if valid write data or a valid write address is stored in the respective memory circuit coupled to that controller circuit. If the controller circuit determines that valid write data or a valid write address is stored in the respective memory circuit, then the controller circuit determines if the available credits indicate that there is enough storage space in the response buffer circuit 301 to store the write data or write address in operation 402. If the controller circuit determines that the available credits indicate that there is enough storage space in the response buffer circuit 301 to store the write data or write address, the controller circuit proceeds to operation 403. Otherwise, the controller circuit can wait for the response buffer circuit 301 to allocate additional storage space for storing write data or write addresses and to indicate the additional storage space by increasing the number of credits available. Operation 402 can be performed by any of the controller circuits 311-318. For example, if controller circuit 311 determines that the memory circuit 321 stores write data or a write address, then controller circuit 311 determines if the available credits indicate that there is enough storage space in the response buffer circuit 301 to store the write data or write address that is currently stored in memory circuit 321 in operation 402.

In operation 403, the controller circuit that performed operation 402 (e.g., one of controller circuits 311-318) generates an interrupt request on the bus 303 to interrupt any signal transmission that is occurring on bus 303. The bus 303 can cause data or address traffic to back-pressure in response to the interrupt request generated by the controller circuit in operation 403. Signal transmission on bus 303 can, for example, be halted, and the data/addresses on bus 303 can be buffered in their current storage locations. Alternatively, the bus 303 can back-pressure the write data or write address in the requesting controller circuit 311-318 or in the respective memory circuit 321-328 in response to the interrupt request generated in operation 403, until the current signal transmission on bus 303 is completed. According to this example, the write data or a write address remains in the controller circuit or in the memory circuit, until signal transmission on bus 303 is completed, and the interrupt request can be serviced. Any of the controller circuits 311-318 can, for example, use the credits to indicate a FIFO queue status in the respective memory circuit 321-328 as full or empty, which can be used to back-pressure the incoming write data or write address.

In operation 404, the controller circuit that performed operations 402-403 transmits the write data or write address stored in the respective memory circuit to the response buffer circuit 301 through the bus 303. In some implementations, each memory circuit 321-328 is assigned to a unique identifier (ID), and only the memory circuits 321-328 having the unique identifiers (IDs) matching IDs associated with the available credits can provide write data or write addresses to the response buffer circuit 301 through bus 303 in operation 404. In operation 405, the response buffer circuit 301 stores the write data or write address received from the controller circuit through the bus 303. In operation 406, the response buffer circuit 301 can optionally transmit the write data or write address through bus 302 to another sub-system in the same IC or externally (e.g., to another memory circuit for performing a write operation).

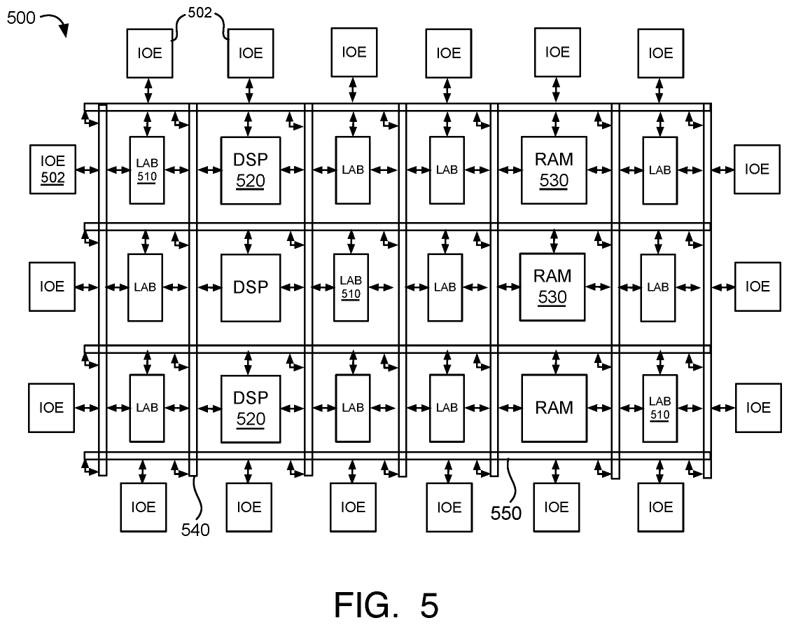

FIG. 5 illustrates an example of a programmable logic integrated circuit (IC) 500 that can include circuits disclosed herein. For example, the programmable logic IC 500 can include any one or more of the circuits shown in FIGS. 1-3 herein and can perform the operations of FIG. 4. As shown in FIG. 5, the programmable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals. In some implementations, RAM blocks 530 can include one or more configurable memory block circuits 100 shown in FIG. 1, the memory block circuits 200 shown in FIG. 2, and/or memory circuits 321-328 shown in FIG. 3 herein. The LABs 510 can include programmable (configurable) logic circuits that can be the logic circuits in fabric region 202 of FIG. 2. A subset of the programmable logic circuits in one or more of the LABs 510 can be the requesting circuits that generate the write data and/or write addresses in signals WDA1-WDA8 in the example of FIGS. 3-4 herein.

In addition, programmable logic IC 500 can have input/output elements (IOEs) 502 for driving signals off of programmable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the programmable logic IC 500 can have input/output elements 502 arranged in different ways. For example, input/output elements 502 can form one or more columns, rows, or islands of input/output elements that may be located anywhere on the programmable logic IC 500.

The programmable logic IC 500 can also include programmable interconnect circuitry in the form of vertical routing channels 540 (i.e., interconnects formed along a vertical axis of programmable logic IC 500) and horizontal routing channels 550 (i.e., interconnects formed along a horizontal axis of programmable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein with respect to FIGS. 1-4 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Programmable logic IC 500 can contain programmable memory elements. Memory elements can be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, programmable logic IC 500 can include configuration memory that is organized in sectors, whereby a sector can include the configuration RAM bits that specify the functions and/or interconnections of the subcomponents and wires in or crossing that sector. Each sector can include separate data and address registers.

The programmable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is an integrated circuit comprising: a buffer circuit; a memory circuit; and a controller circuit to determine whether the memory circuit stores information, the controller circuit to determine whether to transmit the information stored in the memory circuit to the buffer circuit based on credits that indicate an amount of storage space available in the buffer circuit, and the controller circuit to transmit the information to the buffer circuit if the credits indicate that sufficient storage space is available in the buffer circuit to store the information.

In Example 2, the integrated circuit of Example 1 can optionally include, the buffer circuit to change a number of the credits in response to changes in the amount of storage space available in the buffer circuit.

In Example 3, the integrated circuit of any one of Examples 1-2 can optionally include, wherein the memory circuit is one of a set of memory circuits, and wherein the controller circuit is one of a set of controller circuits that determine whether to transmit information stored in the memory circuits to the buffer circuit based on the credits that indicate the amount of storage space available in the buffer circuit and allocated for storing the information stored in the memory circuits.

In Example 4, the integrated circuit of any one of Examples 1-3 can optionally include, the controller circuit to generate an interrupt request on a bus to interrupt signal transmission on the bus prior to transmitting the information to the buffer circuit on the bus.

In Example 5, the integrated circuit of any one of Examples 1-4 can optionally include, the buffer circuit to store the information received from the controller circuit.

In Example 6, the integrated circuit of any one of Examples 1-5 can optionally include, the memory circuit to store the information in response to a write request from a requesting circuit in the integrated circuit.

In Example 7, the integrated circuit of any one of Examples 1-6 can optionally include, the buffer circuit to store and manage the credits that indicate the amount of available storage space in the buffer circuit for storing the information received from the controller circuit.

In Example 8, the integrated circuit of any one of Examples 1-7 can optionally include, wherein the information stored in the memory circuit is one of a write address or write data for a write operation.

Example 9 is a method comprising: determining whether a memory circuit stores information; determining whether to transmit the information stored in the memory circuit to a buffer circuit using a controller circuit based on credits that indicate an amount of available storage in the buffer circuit; transmitting the information from the controller circuit to the buffer circuit through a bus if the credits indicate that enough storage is available in the buffer circuit to store the information; and storing the information in the buffer circuit.

In Example 10, the method of Example 9 further comprises: storing the information in the memory circuit in response to a write request from a requesting circuit.

In Example 11, the method of any one of Examples 9-10 further comprises: changing a number of the credits in response to changes in the amount of storage available in the buffer circuit for storing the information.

In Example 12, the method of any one of Examples 9-11 further comprises: generating an interrupt request on the bus using the controller circuit to interrupt signal transmission on the bus prior to transmitting the information from the controller circuit to the buffer circuit.

In Example 13, the method of any one of Examples 9-12 further comprises: storing the credits in the buffer circuit; and providing the credits to the controller circuit.

In Example 14, the method of any one of Examples 9-13 further comprises: determining whether to transmit information stored in memory circuits to the buffer circuit based on the credits that indicate the amount of available storage in the buffer circuit allocated for storing the information stored in the memory circuits using controller circuits that comprise the controller circuit, wherein the memory circuits comprise the memory circuit.

In Example 15, the method of Example 14 further comprises: transmitting the information stored in the memory circuits from the controller circuits to the buffer circuit through the bus if the credits indicate that enough storage is available in the buffer circuit and allocated to the memory circuits.

Example 16 is an integrated circuit comprising a first configurable memory block circuit, wherein the first configurable memory block circuit comprises: a write address generator circuit to generate a write pointer for a write operation to a first memory circuit; a read address generator circuit to generate a read pointer for a read operation to the first memory circuit; a write control logic circuit to generate a write status control signal that indicates that the first memory circuit is full when a separation between the read pointer and the write pointer reaches a predefined full value; and a read control logic circuit to generate a read status control signal that indicates that the first memory circuit is empty when the separation between the read pointer and the write pointer reaches zero.

In Example 17, the integrated circuit of Example 16 can optionally include, wherein the first configurable memory block circuit further comprises: an address decoder circuit to provide a read address to the first memory circuit for performing the read operation in response to the read pointer, the address decoder circuit to provide a write address to the first memory circuit for performing the write operation in response to the write pointer.

In Example 18, the integrated circuit of any one of Examples 16-17 further comprises: a second configurable memory block circuit comprising a second memory circuit, wherein the first configurable memory block circuit further comprises a multiplexer circuit and a round robin arbiter circuit to manage traffic through the multiplexer circuit between first read data accessed from the first memory circuit during the read operation and second read data accessed from the second memory circuit.

In Example 19, the integrated circuit of Example 18 further comprises: a third configurable memory block circuit coupled to the first configurable memory block circuit, the round robin arbiter circuit to manage traffic through the multiplexer circuit to the third configurable memory block circuit.

In Example 20, the integrated circuit of any one of Examples 16-17 can optionally include, wherein the first configurable memory block circuit further comprises a multiplexer circuit configurable to provide a write control signal from a second configurable memory block circuit or the write pointer to a third configurable memory block circuit.

The foregoing description of the examples has been presented for the purpose of illustration. The foregoing description is not intended to be exhaustive or to be limiting to the examples disclosed herein. In some instances, features of the examples can be employed without a corresponding use of other features as set forth. Many modifications, substitutions, and variations are possible in light of the above teachings.

What is claimed is:

1. An integrated circuit comprising:
a buffer circuit;
a memory circuit; and
a controller circuit to determine whether the memory circuit stores information, the controller circuit to determine whether to transmit the information stored in the memory circuit to the buffer circuit based on credits that indicate an amount of storage space available in the buffer circuit, and the controller circuit to transmit the information to the buffer circuit if the credits indicate that sufficient storage space is available in the buffer circuit to store the information.

2. The integrated circuit of claim 1, the buffer circuit to change a number of the credits in response to changes in the amount of storage space available in the buffer circuit.

3. The integrated circuit of claim 1, wherein the memory circuit is one of a set of memory circuits, and wherein the controller circuit is one of a set of controller circuits to determine whether to transmit information stored in the memory circuits to the buffer circuit based on the credits that indicate the amount of storage space available in the buffer circuit and allocated for storing the information stored in the memory circuits.

4. The integrated circuit of claim 1, the controller circuit to generate an interrupt request on a bus to interrupt signal transmission on the bus prior to transmitting the information to the buffer circuit on the bus.

5. The integrated circuit of claim 1, the buffer circuit to store the information received from the controller circuit.

6. The integrated circuit of claim 1, the memory circuit to store the information in response to a write request from a requesting circuit in the integrated circuit.

7. The integrated circuit of claim 1, the buffer circuit to store and manage the credits that indicate the amount of available storage space in the buffer circuit for storing the information received from the controller circuit.

8. The integrated circuit of claim 1, wherein the information stored in the memory circuit is one of a write address or write data for a write operation.

9. A method comprising:
determining whether a memory circuit stores information;
determining whether to transmit the information stored in the memory circuit to a buffer circuit using a controller circuit based on credits that indicate an amount of available storage in the buffer circuit;
transmitting the information from the controller circuit to the buffer circuit if the credits indicate that enough storage is available in the buffer circuit to store the information; and
storing the information in the buffer circuit.

10. The method of claim 9 further comprising:
storing the information in the memory circuit in response to a write request from a requesting circuit.

11. The method of claim 9 further comprising:
changing a number of the credits in response to changes in the amount of storage available in the buffer circuit for storing the information.

12. The method of claim 9 further comprising:
generating an interrupt request on a bus using the controller circuit to interrupt signal transmission on the bus prior to transmitting the information from the controller circuit to the buffer circuit.

13. The method of claim 9 further comprising:
storing the credits in the buffer circuit; and
providing the credits to the controller circuit.

14. The method of claim 9 further comprising:
determining whether to transmit information stored in memory circuits to the buffer circuit based on the credits that indicate the amount of available storage in the buffer circuit allocated for storing the information stored in the memory circuits using controller circuits that comprise the controller circuit, wherein the memory circuits comprise the memory circuit.

15. The method of claim 14 further comprising:
transmitting the information stored in the memory circuits from the controller circuits to the buffer circuit through a bus if the credits indicate that enough storage is available in the buffer circuit and allocated to the memory circuits.

16. An integrated circuit comprising a first configurable memory block circuit, wherein the first configurable memory block circuit comprises:
a write address generator circuit to generate a write pointer for a write operation to a first memory circuit;
a read address generator circuit to generate a read pointer for a read operation to the first memory circuit;
a write control logic circuit to generate a write status control signal that indicates that the first memory circuit is full when a separation between the read pointer and the write pointer reaches a predefined full value; and
a read control logic circuit to generate a read status control signal that indicates that the first memory circuit is empty when the separation between the read pointer and the write pointer reaches zero.

17. The integrated circuit of claim 16, wherein the first configurable memory block circuit further comprises:
an address decoder circuit to provide a read address to the first memory circuit for performing the read operation in response to the read pointer, the address decoder circuit to provide a write address to the first memory circuit for performing the write operation in response to the write pointer.

18. The integrated circuit of claim 16 further comprising:
a second configurable memory block circuit comprising a second memory circuit, wherein the first configurable memory block circuit further comprises a multiplexer circuit and a round robin arbiter circuit to manage traffic through the multiplexer circuit between first read data accessed from the first memory circuit during the read operation and second read data accessed from the second memory circuit.

19. The integrated circuit of claim 18 further comprising:
a third configurable memory block circuit coupled to the first configurable memory block circuit, the round robin arbiter circuit to manage traffic through the multiplexer circuit to the third configurable memory block circuit.

20. The integrated circuit of claim 16, wherein the first configurable memory block circuit further comprises a multiplexer circuit configurable to provide a write control signal from a second configurable memory block circuit or the write pointer to a third configurable memory block circuit.
